(19) United States
(12) Patent Application Publication
(10) Pub. No.: US 2017/0326568 A1
(43) Pub. Date: Nov. 16, 2017

(54) Automated Unmanned Aerial and Land Vehicle Applications

(71) Applicants: Nagendra Nagarajayya, Pleasanton, CA (US); Rock Clapper, Palo Alto, CA (US); Theodore G. Lewis, Salinas, CA (US)

(72) Inventors: Nagendra Nagarajayya, Pleasanton, CA (US); Rock Clapper, Palo Alto, CA (US); Theodore G. Lewis, Salinas, CA (US)

(73) Assignee: Nagendra Nagarajayya, Pleasanton, CA (US)

(21) Appl. No.: 15/155,060

(22) Filed: May 15, 2016

(51) Int. Cl. B05B 12/08

(52) U.S. Cl. CPC B05B 12/08

(57) ABSTRACT

Horizontal applications and vertical application like lane marking and painting sky scrapers are very time consuming and slow today while inspection of crops is still manual and expensive and hard due to labor problems, etc. This invention describes using a swarm of UXVs to disrupt this space by increasing the speed by 10× to 50× or more saving time, labor and costs increasing productivity.

### CROSS-REFERENCE TO RELATED APPLICATIONS

This application is related to US provisional patent application number 21510356, titled ““Mobile airborne vehicles for dynamic video display” filed Feb. 16, 2015 by the applicant.

This application is related to U.S. provisional patent application No. 62/161,968, titled “Automated Unmanned Aerial and Land Vehicle Applications” filed May 15, 2015 by the applicant.

### FIELD OF THE INVENTION

The present invention relates to using a swarm of unmanned aerial vehicles for horizontal and vertical applications like road lane marking, painting buildings, window washing, construction, crop cultivation/inspection/spraying, etc.

### BACKGROUND OF THE INVENTION

Unmanned vehicles are coming into vogue with their application in military attracting the attention of business' wanting to deploy them to automate manually and time consuming tasks being done today. One such task Is lane marking and painting which is a horizontal application that is done using manual labor or using powered vehicles with many involved in marking the lane. It also takes a long time to mark a lane. Good speeds are about 12 m an hour. It also involves police personnel tied up for hours together, traffic bottlenecks when lane painting is underway, etc. Similarly, sky scraper painting, a vertical application is a very challenging and complex task involving scaffolding or lifts to carry paint workers who have to traverse the length/breadth of the building to paint it. Another horizontal application is in agriculture where crops need to be inspected for diseases, sprayed, watered, etc. These are all done manually as automating them is expensive and hard. Some like watering and spraying are automated but inspection is usually done manually.

This invention uses a swarm of UxVs (unmanned aerial/ground/hybrid vehicles) to replace the manual and tedious task of these horizontal and vertical applications.

### BRIEF DESCRIPTION OF THE INVENTION

Horizontal applications like lane marking and painting are time consuming and slow today. Similarly vertical applications like painting sky scrapers, etc. are expensive and time consuming. Inspection of crops is still manual and expensive and hard due to labor problems, etc. This invention describes using a swarm of UxVs to disrupt this space by increasing the speed by 10× to 50× or more saving time, labor and costs increasing productivity.

### BRIEF DESCRIPTION OF THE DRAWINGS

The accompanying drawings, which are incorporated into and constitute a part of this specification, illustrate one or more embodiments of the present invention and, together with detailed description, serve to explain the principles and implementations of the invention.

FIG. 1—Illustrates the Configuration Management System MCS

FIG. 2—Illustrates a flow of the process for a horizontal application, painting/marking

FIG. 2-1—Illustrates a continuation of the flow from FIG. 2 for a horizontal application, painting/marking

FIG. 2-2—Illustrates a continuation of the flow from FIG. 2-1 for a horizontal application, painting/marking

FIG. 2-3—Illustrates a continuation of the flow from FIG. 2-2 for a horizontal application, painting/marking

FIG. 2-4—Illustrates a continuation of the flow from FIG. 2-3 for a horizontal application, painting/marking

### REFERENCES CITED

### U.S. PUBLISHED APPLICATIONS

### OTHER REFERENCES

### PARENTS CASE TEXT

### DETAILED DESCRIPTION OF PREFERRED EMBODIMENTS

Embodiments of the present invention are described herein in the context of a method and apparatus for emulating a competitive process. Those of ordinary skill in the art will realize that the following detailed description of the present invention is illustrative only and is not intended to be in any way limiting. Other embodiments of the present invention will readily suggest themselves to such skilled persons having the benefit of the disclosure. Reference will now be made in detail to the implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business related constraints, and that these specific goals will vary from one implementation to another and from one developer to another. Moreover, it will be appreciated that such a development effort might be complex and time consuming, but would nevertheless be routine undertaking of engineering for those of ordinary skill in the art having the benefit of this disclosure.

In accordance with the present invention, the components, process steps, and/or data structures may be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, may also be used without departing from the scope and spirit of the inventive concepts disclosed herein.

A number of terms are used herein to describe features of embodiments of the present invention.

As used herein, the term “lane marking” will be used to refer to any of a number of formats (known and to be developed) for marking lanes by an operator or user or viewers or vehicle, [etc.] As used herein, the term “lane marking” may be used to refer to painting lanes on roads. The painting may use paint, studs, glow paste, sensors, etc.

As used herein, the term “painting” will be used to refer to any of a number of formats (known and to be developed) for painting buildings or marking by an operator or user or viewers or vehicle, [etc.] As used herein, the term “painting” may be used to refer to the painting on roads, buildings, etc. The painting may use paint, studs, glow paste, sensors, etc. In an embodiment, painting maybe a series of steps, like first air blowing to clear the target area, a second applying a primer, followed by the paint. In some embodiments, it may also involve stripping or peeling away the existing paint, etc.

As used herein, the term “inspection” will be used to refer to any of a number of formats (known and to be developed) for inspecting crops, buildings, structures, etc. by an operator or user or viewers or vehicle, [etc.] As used herein, the term “inspection” may be used to refer to the inspection of crops, buildings, bridges, structures, etc. The inspection may use different type of sensors 154, vision 155, etc.

As used herein, the term “spraying” will be used to refer to any of a number of formats (known and to be developed) for spraying crops, buildings, structures, etc. by an operator or user or viewers or vehicle, [etc.] As used herein, the term “spraying” may be used to refer to the spraying of crops, buildings, bridges, structures, etc. The spraying may use different type of sensors, vision for input and spray nozzles and spray for output.

As used herein, the term “blocks” will be used to refer to any of a number of formats (known and to be developed) for lifting and dropping blocks, etc. by an operator or user or viewers or vehicle, [etc.] As used herein, the term “blocks” may be used to refer to the use of pre-fabricated component blocks used to build buildings, bridges, structures, etc. The blocks may of various formats, etc. and may use different type of sensors, vision for input to drop and align these blocks into position.

As used herein, the phrase “computer system” is usually made up of a processor, memory, storage, network, clock, input devices and output devices. Input devices can be a keyboard, a pointer device such as a mouse, touch screen, [etc.]. Output devices usually are display, printers, plotters, and controllers, [etc.]. The brain of a computer system is usually the processor such as a microprocessor. A microprocessor executes machine level instructions that enable it to perform logic as well as communicate with the input and output devices. The machine level instructions can be executed with dedicated electronic circuits or use a higher level programmable code that enables the microprocessor to execute a task. The computer system usually at startup, loads an operating system (OS) that manages the input and output devices and also enables executing higher level applications. A server device is a computer based system that usually responds to a client device request. The server device executes a server application that can listen to client requests and respond back with a response. A client device is again a computer based system that communicates across a network with a server device for content. The client device can be a thin client or a thick client. In a thin client, the client device does not handle much processing other than collect input send it across to the server for processing and output the response from the server onto the output devices on the client, like a display, [etc.]. In a thick client, the client device might run an operating system itself, do more processing and communicate with the server device as needed. The communication is usually handled by higher level applications being executed on the client device which make use of networking means to communicate.

As used herein, the phrase “client device” will be used to refer to the device used by a user with or without a display that communicate with a server device. The phrase “client device” has also been used broadly to refer to client applications executing on the device. The client device can be a general purpose computer system with a processor, storage, network connectivity and a display. The client device usually executes a client application, maybe a browser that can communicate across a network with a server device and retrieve content. The retrieved content is shown on the client display. The browser can also execute program code such as JavaScript, Java, [etc.]. Client applications like the browser makes use of the clock signals generated on the client device to enable timer services allowing program code to be executed at regular intervals.

As used herein, the phrase “server device” may be used to refer to a device that executes a server application waiting to respond to a client request. The phrase “server device” has been broadly used to refer to server applications executing on the server device. On a client request such as a request from a browser, the server application sends back content that can be shown on the browser. The content can be text, graphics, sound, media streams, etc. A server device might execute a plurality of server applications, and in an embodiment a server application might itself act as a client and make requests to other server applications executing on the server device or other server devices on the network. A server device usually handles concurrent requests from a plurality of client devices. In an embodiment a plurality of server devices may appear as one to a plurality of client devices to handle the incoming client requests and to scale in performance.

As used herein, the term “control management unit” refers to the management computer system MCS 130 that manages and schedules activity on the UxV server devices and UxV client devices. MCS may employ complex server devices 151,152,154,155 and client devices itself with multiple displays to manage the complex network and communications 120,121 with multiple UXV server devices 152,153 and UXV client devices 101,102,103. The flight path, maneuvers', navigation, formation, units, content type, content application types, etc. are input to MCS so that it can issue the appropriate control sequences to UXV server and client devices. Once the go is issued for a formation, the MCS also manages the system as a whole coordinating with the UXV server and client devices as needed. The MCS may also take the roles of master or a slave node network configuration in a MCS cluster to control the UXV server and client devices.

As used herein, the term UXV server device 152,153 is similar to a server device but maybe a customized application related to operating and controlling UXVs.

As used herein, the term UXV client device 101,102,103 is similar to a client device but maybe a customized application related to controlling and operating UXVs. The UXV client device may run client applications to control piloting, maneuvering, navigation, swarm capability, payload operation, etc. It can communicate with the UXV server device and MCS exchanging application objects and program code. It may have a display and a plurality of target areas.

In an embodiment the UXV client device can be composed of many target areas each separate but grouped together and brought into position as needed. The group of target areas though separate from each other serve to illustrate the content as a whole.

As used herein, the term “flight path” refers to the aerial flight path of a UXV. It may also mean the navigational path for a land based UV It is a pre-planned corridor which an UXV has to follow and be within.

As used herein, the term “navigation” refers to the instrumentation and computer systems used to guide a UXV on a flight path, making use of gps and other navigational signals to control the flight path of the UXV to get a particular destination or swarm capability. The UXV client device may be integrated with this capability and receive control signals from the UXV server device and MCS to manage this.

As used herein, the term “formation” is used to refer to the swarm capability of the UXVs to take up a particular configuration as desired by the MCS.

As used herein, the term “maneuvers” refers to the ability of UXV to navigate itself with control signals from the MCS or using program code and application objects in its computer system to take a flight path, navigate, take up a formation, etc. The UXV client device on the UXV maybe integrated to control this functionality communicating with the MCS as needed.

As used herein, the phrase “target area” will be used to refer to an area on the display device that can be used to show different content types. Content types can be text, graphics, media streams, and sound. The target area is a matrix of pixels that are turned on/off to show content types. Target areas can be grouped together and the content split among these target areas in chunks so that as a whole they form a single display of content.

As used herein, the phrase “target application area” will be used to refer to an area controlled by the target area on the client device to input/output content application types. The target area pixels are used to control the target application area which again is looked at as a matrix of pixels that can be turned on/off to input/output the content application types. Target application areas can be grouped together and the content split among these target application areas in chunks so that as a whole they form a single application area.

As used herein, the phrase “target area type” refers to the type of a target area on the client device. The target area type can be a type that shows dynamic content with motion or still content with sound, sensory, etc.

As used herein, the phrase “target application area type” refers to the type of a target application area controlled by the target area on the client device. The target application area type can be a type that is used for applications like paint, spray, sensory input, sensory output, block retrieve/drop, etc.

As used herein, the phrase “layout” refers to the type of a target area layout on the client device. The layout can be horizontal, vertical, line or any in an embodiment. The layout describes the way how target area object attributes are rendered in the target application area.

As used herein, the phrase “content type” refers to the type of content to be shown in the target area. The content can text, text-image, image, video or any in an embodiment. In another embodiments, the target area container can be linked to or a sensory output device enabling sensory content to be displayed. Sensory content can be text, graphics, sound mixed with signals to control changing the intensity of vibrations, color, smell/aroma, touch, feel, thermal, location, movement, etc.

As used herein, the phrase “content application type” refers to the type of content to be applied in the target application area. The content can be paint, spray, sensory input/output, block drop/retrieve, etc. In an embodiment the sensory input/output can be vision, sound, intensity, color, smell/aroma, touch, feel, thermal, location, movement, etc.

As used herein, the phrase “units or UXV units” refers to the number of UXV units in a swarm and maybe as low as 1.

As used herein, the phrase machine learning server 155 will be used to refer to an Artificial Intelligence server that can learn from previous experience without programming allowing input to be analyzed and provide feedback for more accurate processing.

As used herein, sensory server 154 is used to refer to sensor server that can process information from different type of sensors that maybe electro magnetic. It maybe as simple as measuring temperature or thickness or color to as complex as the radar light sensing signals.

As used herein, the phrase “application object” refers to a data object with attributes. The attributes include a target area, keywords, content type, program code, etc.

As used herein, the phrase “feedback input/output” is feedback received from or sent to the sensory devices in the target application area.

As used herein, the phrase “context” refers to the context of the application

As used herein, the phrase gps refers to Global Positioning System a satellite based navigation system in all weather conditions anywhere on or near earth when there is unobstructed view to at least 4 of these satellites. It is freely available to anyone with a gps receiver. cm gps or RTK gps is a newer version of the gps technology which again uses the satellites to provide cm positional accuracy. LIDAR (Light Detection and Ranging) is another form of remote sensing and surveying using laser and can be used for positional navigation. The term gps is used through the specification to refer to positional navigation using a form of gps like RTK or LIDAR or other forms of electro magnetic sensing.

As used herein, the phrase UXV 140,141,142 refers to unmanned aerial vehicles. It has also been loosely applied and also refers to unmanned ground vehicles and hybrid vehicles ie. vehicles that can fly as well go on the ground. UXVs use gps 110,111,112 to get to a particular geo location. The UXVs carry a payload. UXVs may also be fitted with client devices 101,102,103 that can integrate with the UXVs piloting and payload mechanism.

As used herein, the phrase positional signaling refers to the use of electro magnetic signals between client devices to maintain a fixed and cooperative position between each other. Positional signaling helps UXVs maintain formation, navigate and maneuver as needed. The signaling needs to be extremely fast with the clocks on the all the client devices synchronized with an atomic clock.

As used herein, the phrase payload refers to the load carried by a UXV. It can be as simple as a camera to as sophisticated as a robot with arms integrated into the UXV. The payload mechanism is usually controlled with help of a control unit which in an embodiment maybe the UXV client device.

As used herein, the phrase “swarm” 140,141,142 refers to a plurality of UXVs taking up a particular formation on command from the MCS. The client devices on the UXVs receive the control communication comprised of geo location coordinates and use their gps to get into position. Once they are in position they communicate among themselves by sensing the position of each other through positional signaling. They use positional signaling and the gps to continuously maintain the formation and maneuver as desired by the MCS. A swarm in an embodiment maybe comprised of just a single UXV.

As used herein, the phrase “program code” will be used to refer to code executed in a computer based system. Program code can be in interpreted form or compiled form. In interpreted form the code is at a high level in the form of a programming language and is interpreted one line at a time to execute the code. In compiled form, the program code is analyzed and compiled into a binary form that the computer system can understand and execute as instructions. The operating system of the computer system is usually in compiled form and enables executing applications, tasks, communicate across a network, with input and output devices, [etc.]. Applications can also interpret program code or compile such code to offer more services. A browser is one such application that allows content to be retrieved from a server device. The content is usually HTML. The browser usually executes a JavaScript interpreter so HTML which is a tag language can be associated with dynamic actions. JavaScript is an object oriented language, allowing HTML to be rendered, managed and manipulated on the display device. JavaScript also enables input, output and communication with a server device. A <script> tag usually identifies program code to be executed. The src attribute of the <script> tag is a link and can point to a file containing program code to be executed. The browser while parsing HTML content on recognizing a <script> tag loads the program code from the server device and executes the code using the JavaScript interpreter. The code on execution can create new HTML tags, JavaScript objects, render content, sign up with the timer service, [etc.].

As used herein, the phrase “data object” refers to an object with attributes and methods. Attribute is a specification that defines a property and is usually in the form of a name and value pair. Attributes usually have a type and rules for using the type. A type might be integer, long, character or String, Object, [etc.]. An object of a type integer may allow numbers from 0 to 2̂31−1 to be stored and operated upon. An integer object might be unsigned or signed allowing negative numbers. A character object might store values between 0 and 2̂16−1. A String object might be made up of multiple character objects in sequence. An object method is like a function call but with a namespace and visibility of just the object. Object methods enable manipulating the attributes of the object, like setting or retrieving the attribute value, [etc.] Objects can be extended or aggregated to form higher level types allowing complex structures to be represented and operated upon as objects. An Address object might have attributes, street, description, city, zipcode, state, and country where street might be a String object, description again might be a String object, city might be a String object, zipcode might be a Zipcode object., state might be State object and country might be a Country object. An Address object is an aggregation of multiple objects, while a Zipcode might be an extension of the String object with addition of another String object. The first String object in a Zipcode maybe named zip, while the second String object maybe named geography. The two attributes allow a Zipcode of the form postcode-geography. Methods of the form get Zip, and storeZip enables retrieving and storing zipcodes.

As used herein, the term “browser” may be used to refer to a client application that usually executes on a client device. A web browser is usually referred to as a browser application that is used to browse content on the internet/intranet from a server device. The content usually is tag language based such as HTML but can be others such as XML, XHTML, etc. The browser usually has the capability to show other content. HTML is a tag based language and uses tags to identify content. An HTML document is organized into sections with a “<begin> and “<end>” tag. It begins with a <HTML> tag followed by a <HEAD> tag (section), followed by a <BODY> tag (section). A body tag acts as a container for other tags like <TABLE>, <DIV>, <SPAN>, <P>, <FONT>, [etc.]. The browser renders HTML content onto the display device making use of any Cascading Style Sheets (CSS) usually in the HEAD section to format and style the content rendered. HTML enables a viewer to enjoy print quality visuals on the display. HTML can be associated with program code to create rich action oriented applications. A browser usually includes a program code interpreter or provides such a functionality to execute the program code associated with HTML. A browser also makes use of the timer functionality on a client device enabling program code to be executed at timer intervals. Program code sign up for these timer services using convenience function calls, such as settimer(function, delay), setinterval(function,delay) and clearinterval(id).

As used herein, the term “display” may be used to refer to the display device connected to the client device that allows content to be shown. Display is a piece of electrical equipment usually connected to the video source of the client device. The display can show text, graphics, generate sound, and maybe linked to/show sensory outputs, [etc.]. Display devices usually are (Liquid Crystal Display) LCD based but can be (Cathode Ray Tube) CRT, Plasma or Light Emitting Diode based, [etc.]. Display devices can be part of the client device as in a laptop/tablet/smart phone or separated from the client device as in a general purpose computer.

As used herein, the phrase “clock signal” may be used to refer to a timing means that generates a clock signal periodically on the client device. The client device usually offers a low level Application Programmable Interface (API) enabling an operating system or client device applications to make use of these signals to offer timer services, scheduling, [etc.] Timer services enable program code like shell scripts, application binary code, or at a higher level, an application like a browser with a program code interpreter to offer operating system type of timer services.

As used herein, the phrase “click” refers to a click or change in state of an input device such as a mouse or a joystick button, etc. in a computer based system.

As used herein, the phrase “link” refers to an URL. URLs are Uniform Resource Locators and are of the form http://login:password@address/context?querystring. Address can be a numeric such as an IP address or a hostname.domainname.com. query string can be of the form “parameter=value”.

As used herein, the phrase “query-terms” refers to parameters passed from the client device to the server device as part of a request for an application status/update, etc. Query terms can be keywords or terms of a search such as city, state, country, gps location, [etc.] The query term enables the server device to match the query-term to an attribute target terms, [etc.] in the data objects on the server device and select matching data objects to send back to the client device.

As used herein, the phrase “target-terms” refers to an attribute in the data object allowing the query-terms parameter sent by the client-device to be matched. The server device on receiving a request, uses an index to find matching application object keys. In an embodiment the index might be constructed by feeding the application objects to an index writer. The index writer breaks down the object attributes such as name, description, target terms into words and adds them to index. The index might be of type inverted index. To match using the index, the server device might use an index searcher that goes through the said index and finds all the documents with words that match the said terms. The matching documents could then be used to retrieve keys to the advertisement objects. The matching objects are then returned by the server and can be included in a response.

As used herein, the terms “Ajax”, “XmlHttpRequest” refers to the ability of the client application like a browser executing on a client device to communicate with the server device to retrieve content asynchronously. The XmlHttpRequest can be initiated on a clock signal or a count threshold trigger or a click to retrieve content from the server device; said content can be selectively refreshed onto the display device using a tag like <DIV>. Before the availability of XmlHttpRequest, a request by a browser would stop and pause functions until the request was completed. The returned content was updated as a complete HTML page and caused a flicker as well as long waits. XmlHttpRequest and selective refresh of the client display enables rich application experience with just HTML and JavaScript.

As used herein, the terms “xsocket-http”, “reverse Ajax”, “Server push” refers to the ability of the server device to push content asynchronously to a client device. The server device starts the content push based on an initial request for content from the client device and pushes the content on changes or events on the server devices or client devices. Such events on the server side might be timing means like clock signal timers, or a change of state communication from a client device such as a click or input means. Server push eliminates the need for polling the server device for content by the client device using a clock signal. Polling can be expensive in terms of resources used, while asynchronous server push eliminates the cost of these expensive resources.

As used herein, the terms “websockets”, refers to the ability to communicate between a client and server device in full duplex using TCP communications protocol. Websockets enables port 80, port usually used for browser-server communications and through firewalls to use the http protocol for TCP communications. The TCP communications is layered on top of http protocol with some extra overhead. This is a very useful protocol but is usually not enabled in browsers due to security limitations.

As used herein, the phrase “website” refers to a server device and a server application 160 on the server device that is able to respond back with content, usually HTML based, but could offer other services like email, cloud computing, ftp, [etc.]. A website usually has a name or an IP address. If it has a name it is registered with a name registry so that it can be discovered by users on the internet. The name is usually of the form http/www.name.XXX., where XXX is a Top Level Domain Name (TLD).

As used herein, the phrase “Object converter” refers to a object converter that allows objects with attributes to be represented as Extended Markup Language (XML) or in JavaScript Object Notation (JSON). XML is a tag language that can be used to describe objects with attributes, schemas, [etc.]. HTML tag language is nothing else but XML and is used to describe content to be shown on a display device. XML can be used to describe a Java or a JavaScript language object. The advantage of using XML to describe a language object is it makes the object portable across operating systems, computer systems, and also allows objects to be sent across networks. JSON is another way of representing objects and represents object attributes as name, value pairs. Object converter provides methods that allow a language object to be converted to XML/JSON, and from JSON/XML back to the language objects.

As used herein, the phrase “client sensory input feedback” refers to an input sent from a client device to a server device. The sensory input can be graphics, haptic, motion, magnetic, location, etc.

System

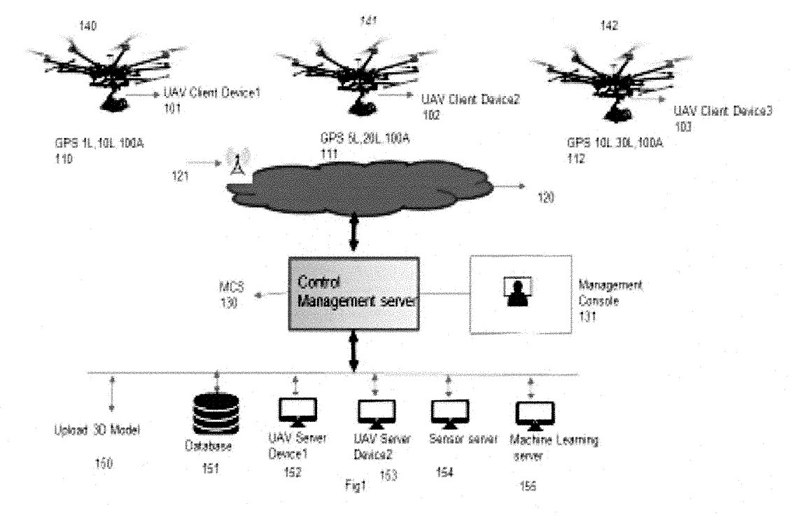

Referring first to an UXV control system FIG. 1 according to embodiments of the present invention is shown. As shown in, the control system includes a control management unit MCS 130, a plurality of UXV client devices (101,102,103), a plurality of UXV server devices 152,153, an operator 131, a swarm of UXVs 140,141,142. MCS manages the control system and provides a visual display of the system. MCS manages the plurality of UXV server devices that in turn communicate and manage the plurality of UXV client devices which in turn manage a plurality of target areas which in turn manage the target application areas. The MCS also directly communicates with the UXV client devices for feedback, etc. The plurality of UXV client devices communicate directly among themselves as well as communicating with the server devices 120,121. The UXV client device is located on a UXV and may also be hooked up to the UXV control unit, controlling the piloting and functions of the UXV. The target area is located on the client device and in turn controls the target application area and content application type. Input is first rendered in the target area triggering mapping of the target area to the target application area using the associated content application type.

In an embodiment, the target application area maybe lane marking with the associated content type, paint. A 3D geographical mapping/model 150 of the road and the lane to be marked is input to the MCS. The MCS goes through the mapping/model and generates commands to the server unit to dispatch a plurality of UXVs with payload of paint as needed to reach the configured swarm capability and as needed for optimum work. The UXV server device generates the flight path, gps geo location map as needed and communicates these in the form of application objects to the UXV client devices in the selected swarm. The UXV client devices programs the autopilot on the UXVs with the flight path, navigates and maneuvers' the UXVs as needed to get to the geo location specified. Once the geo location is reached, client applications receive application objects as input from the server devices, activate the target areas to receive input from the target application area which maybe vision or sensory related and may process the input on the client device or send as feedback to the server device for further processing. The client application then renders the model on the target device activating the drivers controlling the target application area to apply the control application type mapping the contents of the target area, enabling paint to be marked on the road.

Lane marking is composed of a long strip of paint that maybe miles long and continuous or broken. To speed up marking a long strip, the server device may enable a swarm of UXVs breaking the long strip into chunks with each UXV handling a chunk of this space. The client devices communicate among themselves using positional signaling to aid handling chunking and to keep formation as they apply the content application type all over as in the target area that maybe a section as in the model.

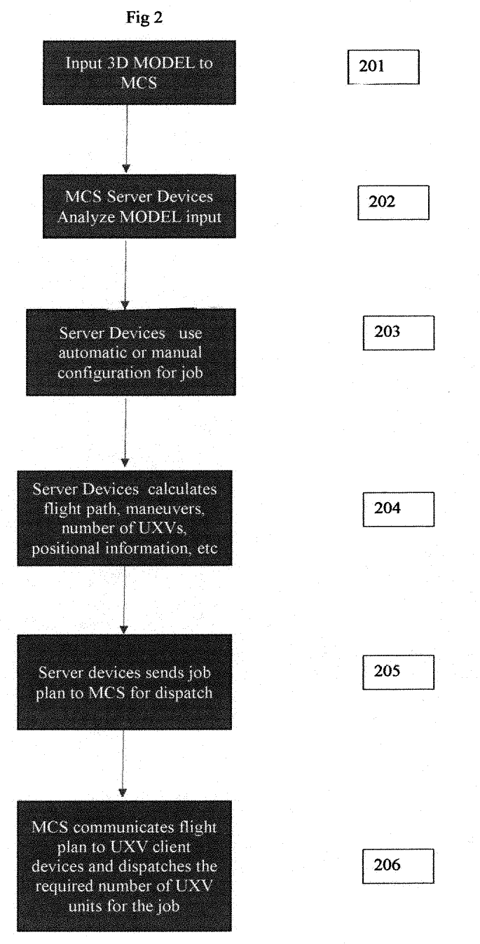

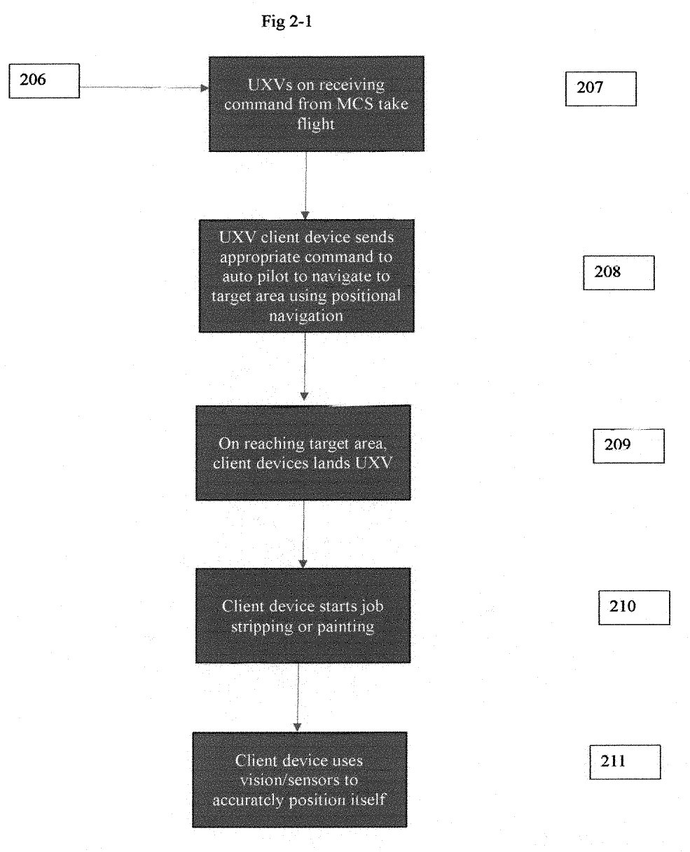

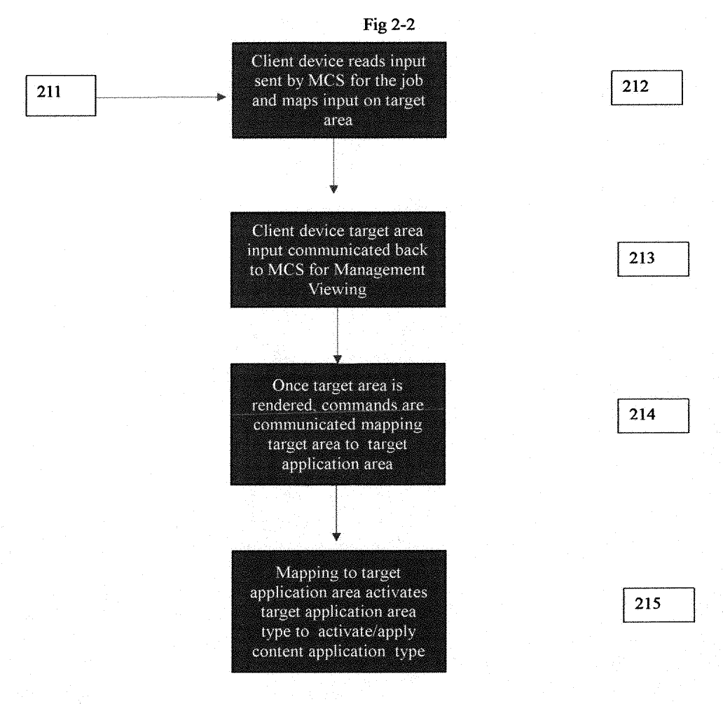

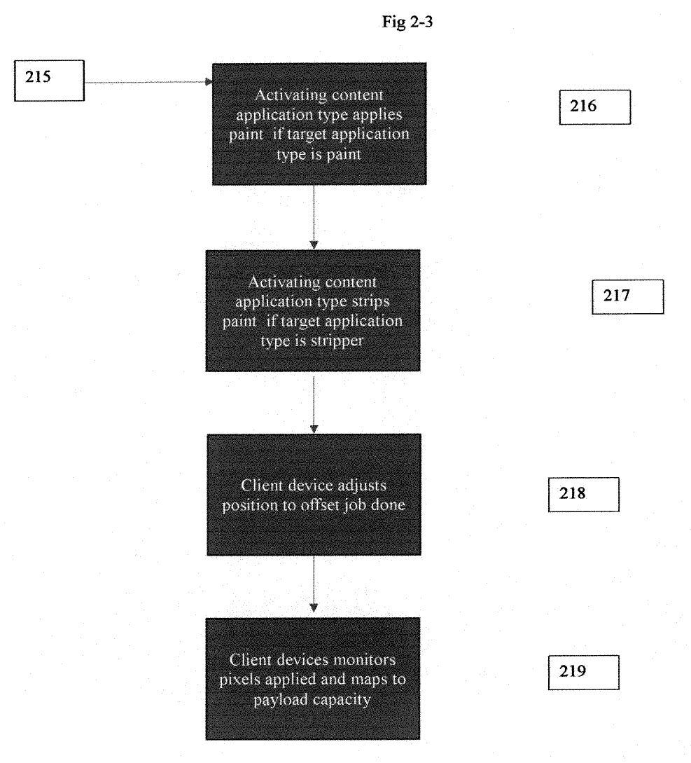

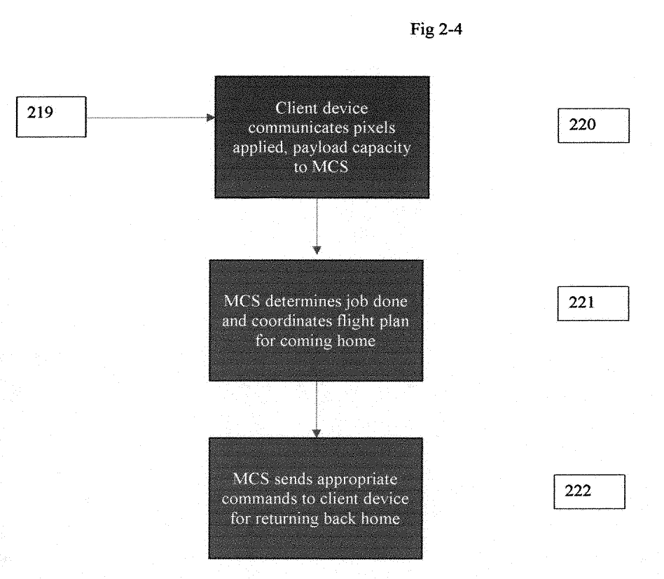

FIG. 2 shows a flow of the steps to paint in an embodiment. 201 shows a 3D model input to MCS by uploading the contents. The model comprises the lane segments and positions to be marked. MCS server devices 202 analyze the model data and based on input provided in the model determine the number of UXVs needed for the job. The input may manually override the automation to request a single UXV, etc. 203. The server applications determine the flight path, maneuver, positional signaling, navigation, number of UXVs needed for the job 204. Once processing is complete, the job is communicated to MCS for dispatch 205. MCS communicates the flight plan, job, etc. to the client devices and dispatches the UXVs 206. UXVs on the job command take flight 207 and the client device application auto pilot the UXV to navigate using GPS and positional navigation to reach the target area 208. On reaching target area, the client device issues appropriate commands to hover and land on target area 209. The client device next initiates the job which maybe stripping paint or new paint to be marked 210. The client device next uses its sensors and vision to accurately position itself 211. The vision and sensory information is sent across to MCS for processing using 154 the sensor server and 155 machine learning server for feedback to position and start job. The input sent by MCS is next mapped to the target area 212. The target area contents are communicated back to MCS for virtual viewing of target area on the MCS console, etc. 213. The target area is next mapped to the target application area 214 activating appropriate controls to activate the target application area type that activate/apply the desired content type 215. In an embodiment the target application area type maybe paint 216 which activates the paint spray gun, positioning the nozzle based on the mapping in the target area mapped to the target application area. Mapping to the target application area activates the target application type which maybe the paint spray nozzle gun which will activate the content type paint. A pixel or a range of pixels can be sprayed with paint the target application content type as mapped in the target application area. Once painted the sensory signals and vision is communicated to 154 and 155 for feedback input. In another embodiment the target application area maybe stripping which activates the strip gun, positioning the nozzle based on the mapping in the target area and the content type would be to strip paint on the road 217. The client device adjusts the position of the nozzle and the UXV to account for the pixel or range of pixels painted 218, while monitoring pixels done and payload capacity 219 and communicating job parameters back to MCS for feedback 220. MCS determines if job is done and creates flight plan to navigate back to home 221 and issues appropriate commands to client device to head back home 222.

In another embodiment, for vertical applications like painting a large sky scraper, the model of the building is again input to the MCS which sends the control signals to the server devices to activate a swarm of UXVs as needed to get into position. Once the geo location is reached, the client device again communicates with the server device sending back vision/sensory inputs while receiving application objects for processing, activating the target areas and the target application areas so that the appropriate driver is enabled to apply the content application type. The client devices again maintain swarm positions using positional signaling while applying the content application type.

Another embodiment would be crop inspection for diseases or damages, etc. The model of the field is input to the MCS which sends control signals to the UXV server devices to enable a swarm of UXVs that on reaching the desired geo location activate the target areas to send back vision and sensory inputs from the target application areas. The client or the server device on further processing may activate more finer sensory inputs (154) and capture the inputs for further processing. If processing reveals a problem in an embodiment, if inspection and spraying components are part of the payload, the client application may activate a spraying application that will render how the spray has to be applied in the target area activating the target application area to apply the appropriate content application type.

In another embodiment instead of inspection, only the spraying component maybe involved so as to use a swarm of UXVs to apply the appropriate content application type as needed only to the parts that need to be sprayed saving on costs, speeding up the spraying process, etc.

In another embodiment, the payload maybe blocks of pre-fabricated components which may need to be dropped into position on top of one another and aligned, etc. Again based on the model the MCS sends across the control commands to the UXV server devices which activates a swarm of UXVs to get into position and use the target areas to collect input about the layout for processing while dropping blocks as needed in pre-determined locations, aligning said block, etc. as a content application type.

While embodiments and applications of this invention have been shown and described, it would be apparent to those skilled in the art having benefit of this disclosure that many more modifications than mentioned above are possible without departing from the inventive concepts herein. The invention, therefore, is not to be restricted except in the spirit of the appended claims.

What is claimed is:

1. A system for automating and speeding up horizontal and vertical applications using unmanned powered vehicles with self-navigation and application capabilities using a swarm of UXVs to enable the application of paint using a target area on the client device attached to the UXV; said target area on the client device is mapped to a target application area which in turn is mapped to a target application area type that maybe of type paint; said target application area type can input/output a content type of said paint; said mapping between target area and target application area enables mapping a pixel on the target area to an application pixel of type paint.
